(19) United States
(12) Patent Application Publication
(10) Pub. No.: US 2008/0120199 A1
(43) Pub. Date: May 22, 2008

(54) METHOD AND SYSTEM FOR UPGRADING A PREVIOUSLY PURCHASED MEDIA ASSET

(76) Inventors: Tracy Pirnack, Los Altos, CA (US); Patrice Gautier, San Francisco, CA (US); Debra Ameerally, Sunnyvale, CA (US); Hiro Mitsuji, San Francisco, CA (US); Alan Ward, Thornton, CO (US)

Correspondence Address: BEYER LAW GROUP LLP/APPLE INC., P.O. BOX 1687, CUPERTINO, CA, 95015-1687, US

(21) Appl. No.: 11/561,336

(22) Filed: Nov. 17, 2006

(51) Int. Cl. G06F 17/30

(52) U.S. Cl. 705/27

(57) ABSTRACT

Systems and methods for upgrading from one or more digital media assets to a set of digital media assets over a network are described. A potential purchaser can be notified of available upgrade opportunities that are available for purchase. The potential purchaser can elect to pursue an upgrade opportunity so as to purchase a set of digital media assets. Upon upgrading to the set of digital media assets, the digital media assets within the set of digital media assets are made available to the purchaser. Typically, on upgrading from one or more of the digital media assets in the set of digital media assets to the entire set of digital media assets, the purchaser pays a lower cost than would be otherwise charged if the purchaser were to purchase the set of digital media assets in a non-upgrade manner.

### BACKGROUND OF THE INVENTION

1. Field of the Invention

The present invention relates to digital media assets and, more particularly, to network-based purchase of sets of digital media assets.

2. Description of the Related Art

Today, it is common for users to access online media repositories to purchase songs or tracks online. Recently, online media repositories have supported videos, such as movies or television shows. The typical interaction with an online media repository is that a user will browse the online media repository, select one or more media items to be purchased or otherwise acquired, and then receive electronic delivery of the items over a network. One example of an online media repository is an on-line media store, such as the iTunes Music Server® provided by Apple Computer, Inc.

Often, a user purchases an individual track or song from an online media repository. In many cases the individual track or song will be associated with an album. The album includes a number of different tracks or songs, some or all of which can be purchased individually. For example, a user may purchase one or two songs individually as opposed to purchase of the album. As a result, the user pays a lower cost than the cost of the album but only acquires a portion of the album. The user can thereafter continue to buy other individual tracks or songs from the album to acquire some or all of the remaining tracks or songs of the album. Alternatively, the user could buy the album as a set. However, on buying the album, the user would be charged for the cost of the entire album, even though the user might have previously purchased one or more tracks from the album. As a result, in this conventional scenario, users tend not to purchase albums after they have purchased one or more individual tracks from an album.

An album is a set of media items. The media items are usually tracks of audio recordings (i.e., songs). Upon purchase of an album, conventionally, all of the tracks of the album are downloaded to the user. To the extent that the user has previously purchased certain of the tracks from the album, the user not only pays for some tracks it does not need, but also computing and network resources are wasted when the unneeded tracks are sent and received over the network to the user. Thus, there is a need for improved approaches to facilitate a user's acquisition of sets of media items.

### SUMMARY OF THE INVENTION

The invention pertains to a system and method for upgrading from one or more digital media assets to a set of digital media assets over a network. A potential purchaser can be notified of available upgrade opportunities that are available for purchase. The potential purchaser can elect to pursue an upgrade opportunity so as to purchase a set of digital media assets. Upon upgrading to the set of digital media assets, the digital media assets within the set of digital media assets are made available to the purchaser. Typically, on upgrading from one or more of the digital media assets in the set of digital media assets to the entire set of digital media assets, the purchaser pays a lower cost than would be otherwise charged if the purchaser were to purchase the set of digital media assets in a non-upgrade manner.

The invention can be implemented in numerous ways, including as a method, system, device, apparatus (including graphical user interface), or computer readable medium. Several embodiments of the invention are discussed below.

As a computer-implemented method for upgrading a prior purchase of a user, one embodiment of the invention includes the acts of: identifying the user as having previously made a prior purchase of an item from a particular online content provider; determining whether the prior purchase is eligible for upgrade to a bundle of items, where the item is one of the items in the bundle of items; notifying the user of their eligibility to upgrade to the bundle of items; determining whether the user requests to upgrade to the bundle of items; and transacting the upgrade from the particular online content provider when the determining determines that the user desires to upgrade to the bundle of items.

As a computer readable medium including at least computer program code for offering an upgrade from a prior purchase of a media item to a set of media items that includes the media item, one embodiment of the invention includes at least: computer program code for identifying the user as having previously made a prior purchase of a media item from a particular online content provider; computer program code for determining whether the prior purchase is eligible for upgrade to a set of media items, where the media item is one of the media items in the set of media items; and computer program code for notifying the user of their eligibility to upgrade to the set of media items.

As a computing device, one embodiment of the invention includes at least one data storage device and a data processing unit. The data storage device can be configured to store digital media assets and digital media asset information that contains characteristics of the digital media assets. The data storage device can be further configured to store purchase history information. The digital media asset information can include information on sets of the digital media assets that can be acquired. The data processing unit can be configured to perform at least: an upgrade process to determine one or more available upgrade opportunities for one or more users based on the purchase history information, the upgrade opportunities pertaining to one or more of the sets of the digital media assets; a notification process to notify one or more users of the one or more available upgrade opportunities; and an acquisition process to enable the one or more users to upgrade to one or more of the sets of the digital media assets.

As a graphical user interface, one embodiment of the invention includes at least a media upgrade window. The media upgrade window can include at least (i) a media descriptive portion providing information concerning a media bundle available from an on-line media store, and (ii) a media item listing area providing a listing of a plurality of media items within the media bundle. A portion of the media items in the listing can be visually distinguished from other of the media items in the listing. The portion of the media items being visually distinguished can be those of the media items within the media bundle that have been previously acquired from the on-line media store. Moreover, a remaining portion of the media items in the listing can be made available to be acquired by upgrading to the media bundle.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a media purchase system according to one embodiment of the invention.

FIG. 2 is a diagram of an upgrade system according to one embodiment of the invention.

FIG. 3 is a diagram illustrating a client-server upgrade arrangement according to one embodiment of the invention.

FIG. 4 illustrates a diagram of an upgrade eligibility system according to one embodiment of the invention.

FIG. 5 is a flow diagram of an upgrade process according to one embodiment of the invention.

FIG. 6 is a flow diagram of an upgrade eligibility process according to one embodiment of the invention.

FIG. 7A is a flow diagram of a payment process according to one embodiment of the invention.

FIG. 7B is a flow diagram of a payment process according to another embodiment of the invention.

FIG. 7C is a flow diagram of a payment process according to another embodiment of the invention.

FIG. 8 is a flow diagram of an upgrade request process according to one embodiment of the invention.

FIG. 9 is a diagram of a representative media season window according to one embodiment of the invention.

FIG. 10 is a flow diagram of a media bundle purchase process according to one embodiment of the invention.

FIG. 11 shows an exemplary computer system suitable for use with the invention.

### DETAILED DESCRIPTION OF THE INVENTION

The invention pertains to a system and method for upgrading from one or more digital media assets to a set of digital media assets over a network. A potential purchaser can be notified of available upgrade opportunities that are available for purchase. The potential purchaser can elect to pursue an upgrade opportunity so as to purchase a set of digital media assets. Upon upgrading to the set of digital media assets, the digital media assets within the set of digital media assets are made available to the purchaser. Typically, on upgrading from one or more of the digital media assets in the set of digital media assets to the entire set of digital media assets, the purchaser pays a lower cost than would be otherwise charged if the purchaser were to purchase the set of digital media assets in a non-upgrade manner.

In one embodiment, an on-line media store makes sets of digital media assets available. A potential purchaser can access the on-line media store over a network connection (wired or wireless) and then browse, search and/or purchase sets of digital media assets. One type of purchase is an upgrade purchase. With an upgrade purchase, the cost for the upgrade is typically less than the cost of purchasing the set of digital media assets without upgrading. The purchased digital media assets can be electronically delivered, such as from the on-line media store.

The digital media assets can be audio, graphic, video, or some combination thereof. A set of digital media items is a group of digital media assets. A set of digital media assets can, for example, pertain to a group, collection or bundle of digital media assets. As examples, a set of digital media assets can pertain to an album (i.e., a set of songs), a television series or season (i.e., a set of television shows/episodes), a photo album (i.e., a set of photos or images), a video album (i.e., a set of videos), or a set of podcasts (i.e., a set of podcast episodes). A set of digital media assets can also include or be supplemented by text or multimedia files.

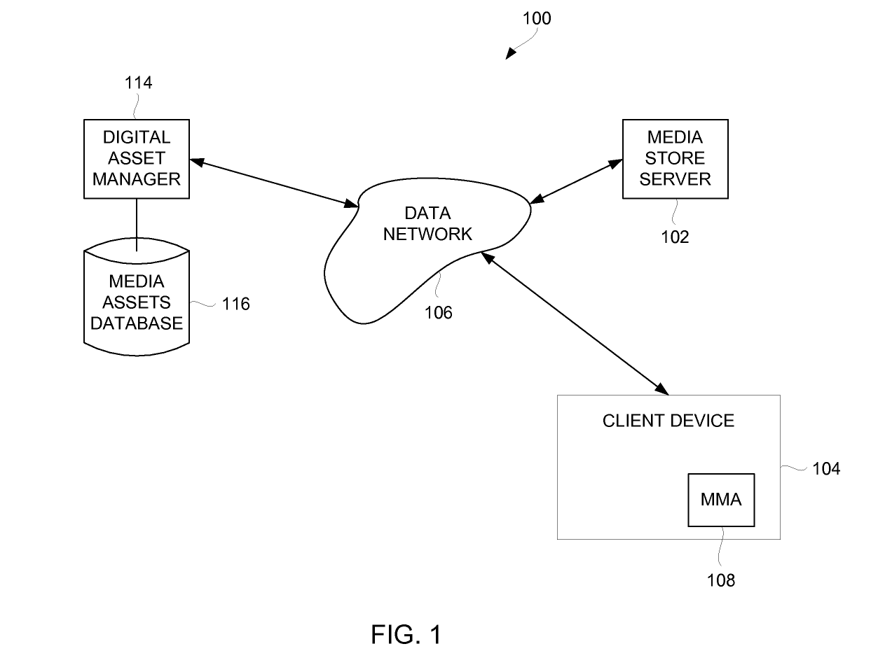

Embodiments of the invention are discussed below with reference to FIGS. 1-11. However, those skilled in the art will readily appreciate that the detailed description given herein with respect to these figures is for explanatory purposes as the invention extends beyond these limited embodiments.

FIG. 1 is a block diagram of a media purchase system 100 according to one embodiment of the invention. The media purchase system 100 includes a media store server 102 that hosts an on-line media store. The media store server 102 can off-load commerce transactions and/or delivery of purchased digital media assets to other servers, if desired. As shown in FIG. 1, the media purchase system 100 includes one or more client devices 104 for use by end users. The client devices 104 couple to a data network 106. Additionally, the media store server 102 also couples to the data network 106. In one implementation, the data network 106 can refer to one or more data networks, typically, high data-bandwidth networks, namely, wired networks, such as the Internet, Ethernet, gigabit Ethernet, and fiber optic, as well as wireless networks such as IEEE 802.11(a), (b) or (g) (WiFi), IEEE 802.16 (WiMax), and Ultra-Wide Band (UWB).

A computer program 108, typically a media management application (MMA) or other media player application, runs on the client device 104. One example of a media management application is the iTunes® application, produced by Apple Computer, Inc. of Cupertino, Calif. The client devices 104 are, in general, computing devices. As an example, the client devices 104 can be specific or general-purpose personal computers or portable media players. The computer program 108 can be used by a consumer for a variety of purposes, including, but not limited to: (i) browsing and/or purchasing media assets (including sets of media assets) from the on-line media store provided by the media store server 102, (ii) creating and sharing media asset groups (e.g., playlists), (iii) organizing media assets, (iv) presenting/playing media assets, and/or (v) transferring media assets between client devices 104. In an alternative embodiment, the computer program 108 can be a network browser application (e.g., web browser).

The media purchase system 100 can also include a digital asset manager 114. The digital asset manager 114 is coupled to a media assets database 116. The media assets database 116 stores media asset information including metadata relating to digital media assets available for purchase at the on-line media store. In one embodiment, the digital asset manager 114 can control what media assets and media asset information are available on the on-line media store. The metadata can pertain to individual media assets (digital media assets) or media asset groups (digital media asset groups). One type of group of digital media assets is an album, such as an audio album or a video album. Another type of group of digital media assets is a season or a series of media assets (e.g., television series or movie sequels). The digital assets within a media asset group can include video, music, text, and/or graphics files.

The media store server 102 enables the user of a particular client device 104 to purchase a set (e.g., group or collection) of media assets through on-line transactions, such as an upgrade transaction. On-line transactions to purchase media items are also referred to as electronic commerce (e-commerce). Subsequently, the client device 104 can download the purchased media assets from the media store server 102, or some other server, such as the digital asset manager 114, via the data network 106. As will be understood by those familiar with data networks, other network configurations are possible. Furthermore, while the media store server 102 and the digital asset manager 114 are shown as individual and separate devices, it will be understood by those familiar with the art that other configurations are possible. As one example, each device can be implemented such that it is distributed over multiple server computers. As another example, these various servers and/or managers can be implemented by a single physical server computer.

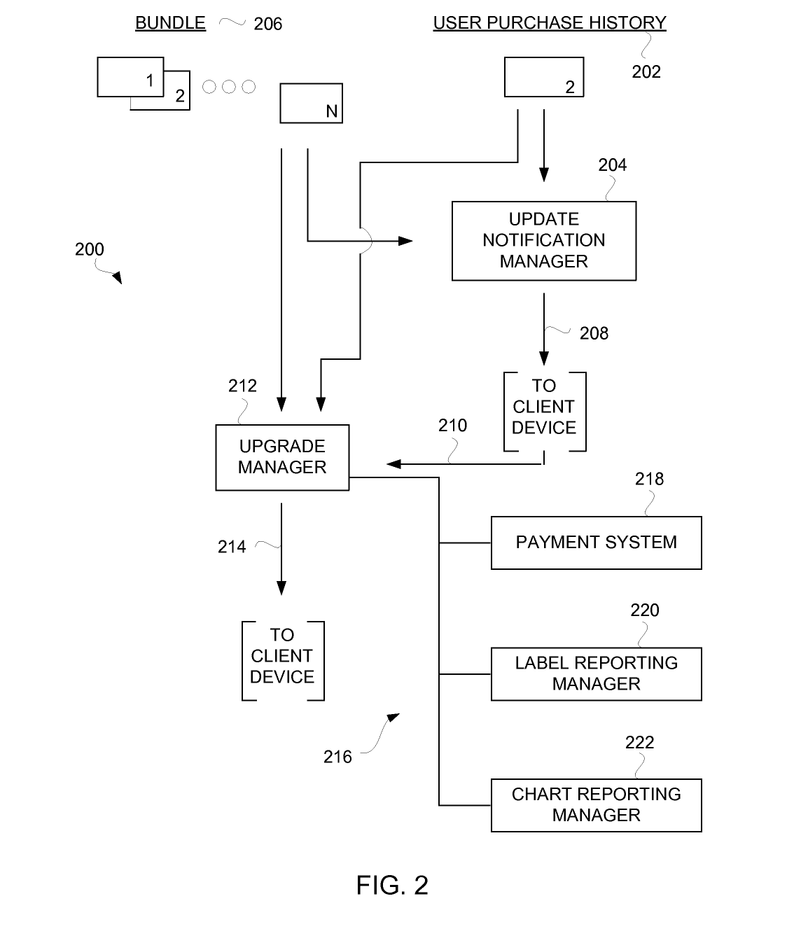

FIG. 2 is a diagram of an upgrade system 200 according to one embodiment of the invention. The upgrade system 200 can, for example, be performed by a server (server computer). For example, the server can correspond to the media store server 102 or the digital media manager 114 illustrated in FIG. 1.

The upgrade system 200 facilitates users in upgrading from individual media items to bundles of media items. According to the upgrade system 200, a user purchase history 202 can identify one or more media items previously purchased by a user. An upgrade notification manager 204 can make use of the user purchase history 202 as well as information concerning available bundles 206 of media items that are available from the upgrade system 200. The upgrade notification manager 204 can operate to send notifications 208 to one or more client devices. The notifications remind, encourage or entice users to upgrade to bundles of media items.

A user, in response to the notification message or otherwise, can send a request 210 to update from one or more media items to a bundle of media items. The upgrade request 210 is provided to an upgrade manager 212. The upgrade manager 212 manages processing associated with upgrading the user from their prior purchase of one or more media items from the bundle to their purchase of the entire bundle. The upgrade manager 212 can make use of the user purchase history 202 and information concerning the bundles 206. Using this information, the upgrade manager 212 can determine those media items from the bundle 206 that need to be delivered to the client device. The determined media items can then be sent 214 to the client device. In one embodiment, only those media items within the bundle that the user does not already have (from prior purchases) are sent to the client device associated with the user. In another embodiment, the entire bundle 206 could be delivered 214 to the user via the client device. The upgrade manager 212 can further interact with other subsystems 216. The subsystems 216 can include a payment system 218, a label reporting manager 220 and a chart reporting manager 222.

In one embodiment, the items in the bundles are associated with media, such as songs, videos, television programs, podcasts and other media. Typically, media items of such media are available individually or as a bundle. With media of this nature, in many cases, the copyright owners and/or the media industry require reporting purchases for royalties, charting, or other purposes. The label reporting manager 220 can operate to report to a label that prior user purchases have been refunded and that a bundle has instead been purchased. The chart reporting manager 222 can inform a charting organization that a bundle has been purchased and that prior user purchases have been returned or refunded.

The payment system 218 can process payment for the upgrade to a bundle. The payment can be dependent upon the portion of the bundle that the user has already purchased. The payment can be processed as an upgrade cost. Alternatively, the payment can be processed in two steps, namely, (i) a refund of prior purchases and (ii) a purchase of the entire bundle. Typically, the bundle has a cost and the upgrade cost is less than the bundle cost given that the user has some portion of the bundle already. The payment system 218 can also handle royalty payments to a label or other entity/person. The royalty payment can be processed as an upgrade royalty. Alternatively, the royalty payment can be processed in two steps, namely, (i) a royalty refund of royalty previously paid for prior purchases and (ii) a royalty payment for purchase of the entire bundle.

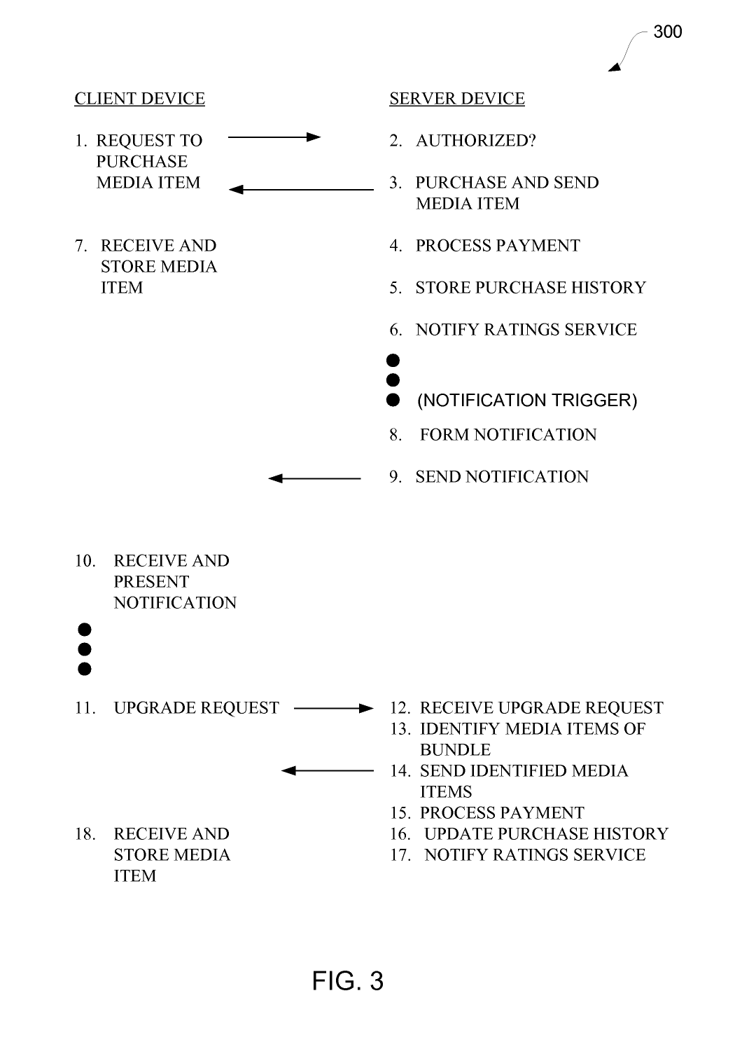

FIG. 3 is a diagram illustrating a client-server upgrade arrangement 300 according to one embodiment of the invention. The client-server upgrade arrangement 300 illustrates processing performed at a client device as well as processing performed at a server device. The sequence of steps illustrated in FIG. 3 that are performed between the client device and the server device only represent one embodiment of the invention. Hence, it should be recognized that other processing sequences can be utilized.

In FIG. 3, initially, at the client device, a request to purchase a media item is sent to a server device (step 1). The server device then determines whether the user is authorized to make the requested purchase (step 2). Assuming that the user is authorized, the media item that has been requested is purchased and then sent to the client device (step 3). Hence, the server device processes payment for the media item (step 4) and stores information concerning the purchase as purchase history (step 5). The server device can also notify a ratings service (or charting service) (step 6). At the client device, the media item is received and stored (step 7). At this point, the media item is available for use at the client device.

At the server device, subsequent to the purchase and delivery (and other associated processing) for a media item, a notification trigger can occur. The notification trigger is a trigger for the server device to evaluate which users should receive notifications concerning upgrade opportunities. In this regard, a notification is formed (step 8) and then sent to the client device (step 9). The client device that receives the notification is able to present the notification (step 10). The notification can be presented in a variety of different ways depending upon implementation and type of notification being provided by the server device. In any case, sometime after being presented with the notification, the client device can issue an upgrade request to the server device (step 11). When the server device receives the upgrade request (step 12), the server device can identify the bundle associated with the upgrade request (step 13). Then, those missing media items for the bundle are sent to the client device (step 14). The server device can further perform financial transactions to process payment for the purchase of the bundle and/or for royalty payments (step 15). Still further, the purchase history associated with the user can be updated at the server device (step 16). Further still, a ratings (or charting) service can be notified that the user has upgraded from the one or more individual purchases to the entire bundle (step 17).

After the media items needed to complete the bundle are sent from the server device to the client device, the client device receives and stores the media items (step 18). At this point, the client device stores the entire bundle, namely, the client device stores each of the media items within the bundle. Thereafter, the client device is able to play or further transmit any of the media items associated with the bundle.

Payment processing can be implemented in one or more transactions. At step 4 of the client-server upgrade arrangement 300, according to one example, a first transaction can be a financial transaction to pay the cost of the media item being purchased. Also, if a royalty payment is required, step 4 can include a second transaction which can be a financial transaction to pay a royalty associated with the purchase of the media item.

At step 15 of the client-server upgrade arrangement 300, according to a first example, the server device can perform a first financial transaction to refund prior payment for any individual media items within the bundle that the user already has purchased, and a second financial transaction to process payment for the cost of the bundle. Alternatively, at step 15, according to a second example, the server can perform a financial transaction to process payment for the upgrade cost of the bundle. Beyond the payments for the media, when royalty payments are required, step 15 can further include process of any required royalty payments. Here, the royalty payments can be in a single or multiple transactions. In one example, as a single transaction, the royalty payment can be process as the appropriate royalty for the upgrade. In another example, as multiple transactions, the royalty payment can be processed as a first financial transaction to pay a royalty due for the bundle (i.e., an entire bundle) and a second financial transaction to acquire a refund of any previously paid royalty associated with earlier purchase of individual media items within the bundle.

In order to determine which users or client devices should receive upgrade notifications, the system needs to determine which users have purchased individual media items that are associated with media bundles that can be upgraded. Such users can be denoted as being eligible for an upgrade from individual media items to media bundles.

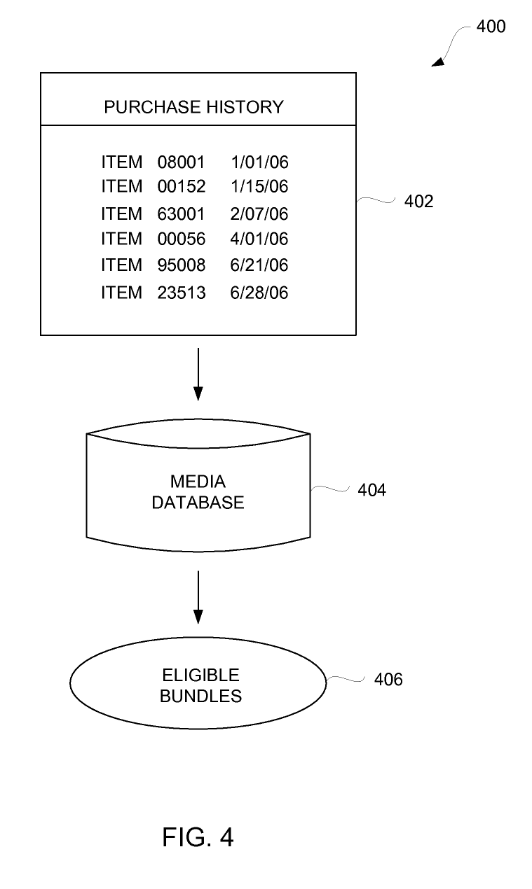

FIG. 4 illustrates a diagram of an upgrade eligibility system 400 according to one embodiment of the invention. The upgrade eligibility system 400 can, for example, be utilized by the upgrade notification manager 204 illustrated in FIG. 2. The upgrade eligibility system 400 utilizes purchase information 402. The purchase information 402 can pertain to the user purchase history 202 illustrated in FIG. 2. The upgrade eligibility system 400 analyzes each item previously (and recently) purchased by a user. Typically, the purchase history will identify the item by a unique identifier as well as a date of purchase. Using the date of purchase, the upgrade eligibility system 400 can restrict upgrade opportunities to those media items that have been more recently purchased. For example, only those media items purchased within 180 days could be eligible for upgrade. In the example illustrated in FIG. 4, the purchase history contains six media items that were purchased on different days. If the upgrade eligibility system 400 only permits user purchases within the last six months (e.g., 180 days) to be upgraded, and the current date is Aug. 1, 2006, then only four of the previously purchased items are eligible to be considered for upgrade. Those of the media items that are eligible for upgrade can be provided to a media database 404. The media database 404 can determine which of those eligible media items is available to be upgraded. In particular, a particular media item can be associated with a particular bundle. For example, the unique identifier for a previously purchased media item can be associated with a bundle via the media database 404. The media database 404 can provide information linking the particular media item to an associated media bundle as well as information indicating whether the media bundle is available for upgrade. When a media bundle is available for upgrade, the media bundle is permitted to be transacted as part of an upgrade from a prior purchase. Assuming that the associated media bundle is eligible for upgrade, the upgrade eligibility system 400 then identifies eligible bundles 406. Thereafter, the user associated with the purchase history 402 can be notified that the eligible bundles 406 are made available to them should they wish to upgrade. The user can then request to upgrade to one or more of the eligible bundles 406.

The eligible bundles 406 can pertain to one or multiple types of digital media assets. As one example, if a previously purchased media item is an audio track (e.g., song), then the eligible bundle 406 can be an album (music album). As another example, if a previously purchased media item is a television show episode, then the eligible bundle 406 can be a series or set of episodes of a show or event. Television shows are typically daily or weekly programs. As such, a set or season of a television show includes a number of different episodes that are broadcast over the course of the season. As still another example, if a previously purchased media item is a video track (e.g., song), then the eligible bundle 406 can be a video album.

A media season can include all episodes of a show (e.g., television show) or event (e.g., sporting event) corresponding to a particular media season. A media season can consist of a predetermined number of consecutive episodes of a show or event. For example, the media season being purchased can be defined as forward looking, meaning that only a current episode and future episodes are contained in the media season for the registered user. Consequently, different registered users can get a different set of episodes depending on when they purchase the media season. A media season can include episodes containing audiovisual content regarding highlights of one or more events, shows, or programs. For example, the media season can be audiovisual highlights for a particular sporting event.

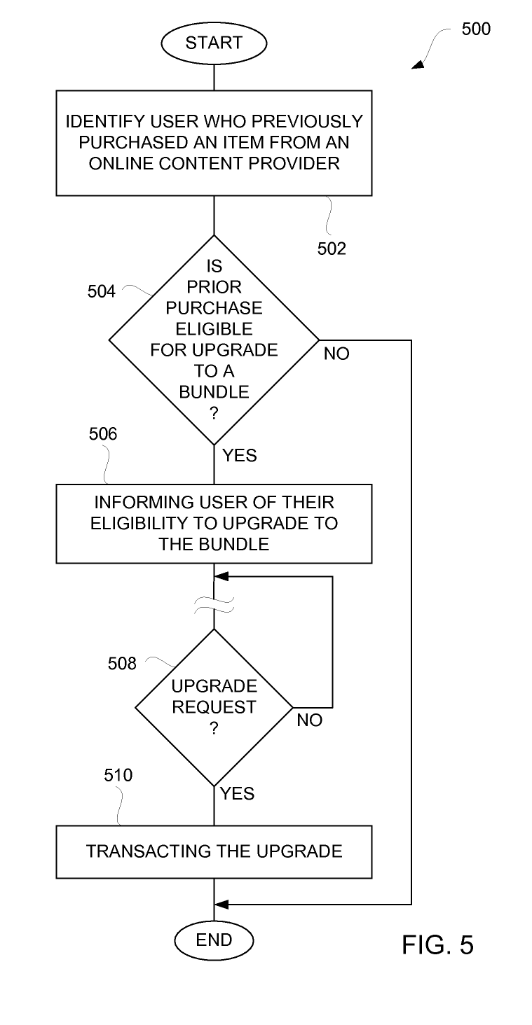

FIG. 5 is a flow diagram of an upgrade process 500 according to one embodiment of the invention. The upgrade process 500 is performed by a server (server computer). For example, the server can correspond to the media store server 102 or the digital media manager 114 illustrated in FIG. 1.

The upgrade process 500 initially identifies 502 a user who has previously purchased an item from an online content provider. In one embodiment, the online content provider can store purchase history information for its users. The server can then subsequently analyze the purchase history to determine those users that have previously purchased items from the online content provider.

Next, a decision 504 determines whether there are any prior purchases that are eligible for upgrade to a corresponding bundle. When the decision 504 determines that the prior purchases of the user are not eligible for upgrade to one or more bundles, then the upgrade process 500 ends. On the other hand, when the decision 504 determines that one or more prior purchases of the user are eligible for upgrade to a corresponding bundle, the user can be informed 506 of their eligibility to upgrade to the corresponding bundle. In another implementation, the user can be informed 506 by way of an upgrade notification message. The upgrade notification message can be an electronic mail message that is electronically sent to the user. In one implementation, the electronic mail message can include a hyperlink to a web page (or network address) where the corresponding bundle is described and where upgrade to the bundle can be initiated via user interaction with the web page. In another embodiment, the user can be informed 506 of their eligibility to upgrade to one or more bundles when they login to an online content provider or as they utilize a media store hosted by an online content provider.

In any case, after the user has been informed 506 of their eligibility to upgrade to one or more bundles, a decision 508 can be performed. The decision 508 can be performed immediately after the informing 506 or some time thereafter depending upon the type of notification and the time in which the user decides to upgrade to one or more bundles. Hence, the decision 508 determines whether an upgrade request has been received. Typically, the upgrade request would be initiated by the user when the user desires to upgrade to a particular bundle. When the decision 508 determines that an upgrade request has not been received, then the upgrade process 500 effectively awaits the upgrade request. In the interim, other processing can be performed by the server. Once the decision 508 determines that an upgrade request has been received, the upgrade can be transacted 510. The transaction for the upgrade can include providing the additional content (e.g., digital media content) associated with the upgrade to the user. In addition, the transacting 510 can also include one or more of payment processing, label or chart processing, or other service reporting. Following the block 510, the upgrade process 500 ends.

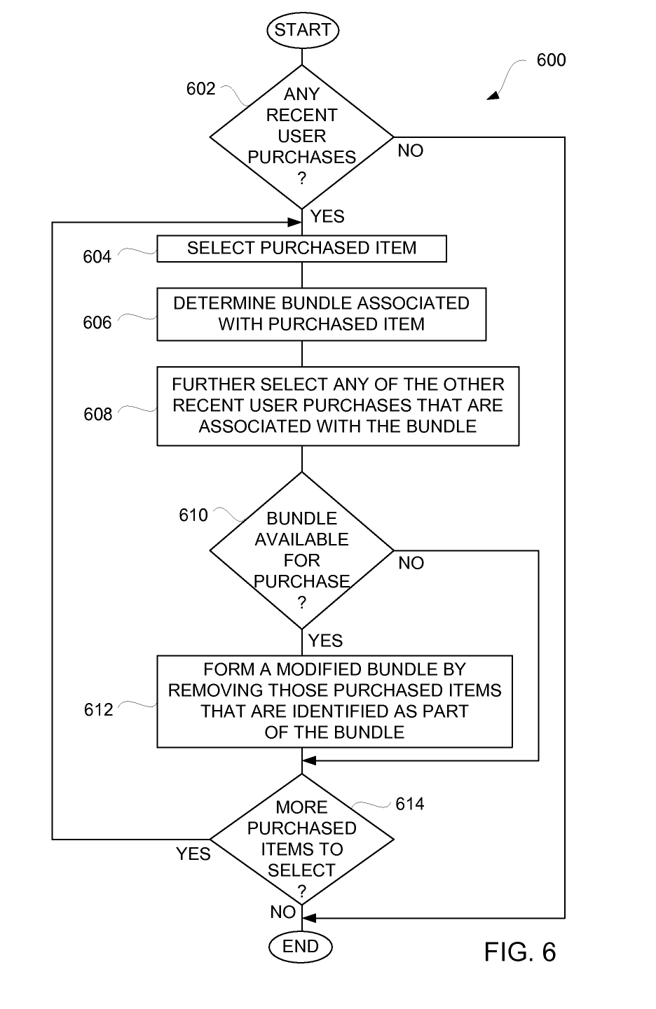

FIG. 6 is a flow diagram of an upgrade eligibility process 600 according to one embodiment of the invention. The upgrade eligibility process 600 is, for example, performed by the decision 504 to determine whether prior purchases of a particular user are eligible for upgrade to associated bundles.

The upgrade eligibility process 600 begins with a decision 602. The decision 602 determines whether there are any recent user purchases. Here, the prior purchases that are eligible for upgrade can be limited to those user purchases that have been recently performed. As an example, a recent purchase can be considered any purchase with an online content provider that has been transacted within the last 180 days. As another example, the recent user purchase can be any purchase with an online content provider within the last six months or within the same calendar year. More generally, the decision 602 can utilize a business rule in determining which prior purchases are available for upgrade.

When the decision 602 determines that there are no recent user purchases, the upgrade eligibility process 600 ends without having any upgrade opportunities for the user. Alternatively, when the decision 602 determines that there are recent user purchases, a purchase item is selected 604. The bundle associated with the purchased item is then determined 606. Next, any of the other recent user purchases that are associated with the bundle are further selected 608. For example, if the bundle concerns an album of music, and the user has recently purchased tracks (i.e., songs) 1 and 3 of the ten (10) track album, then the track 1 being the selected purchased item and the track 3 being the other recent user purchase that are associated with the same album can be consolidated into one upgrade opportunity.

A decision 610 then determines whether the bundle is available for purchase in the upgrade context. There may be some limitations on the extent to which a bundle is available for purchase. As an example, the bundle upgrade may be prohibited from being utilized in an upgrade fashion. As another example, the bundle may be permitted only in certain situations, such as if only one item from the bundle has been previously purchased. As still another example, if most of the media items in the bundle have been previously purchased, the bundle upgrade may not be permitted. For example, the upgrade cost to complete the bundle can be restricted to those upgrade opportunities that have a minimum cost. In any event, when the decision 610 determines that the bundle is available for purchase, a modified bundle is formed 612 by removing those previously purchased items that are identified as part of the bundle.

Following the block 612 or following the decision 610 when the bundle is not available for purchase, a decision 614 determines whether there are more purchased items to be selected. Here, the decision 614 determines whether there are other recent user purchases that have not yet been processed. When the decision 614 determines that there are more recent user purchases to be considered, the upgrade eligibility process 600 returns to the block 604 so that another recently purchased item can be selected and similarly processed. On the other hand, when the decision 614 determines that there are no more purchased items to be selected, the upgrade eligibility process 600 ends.

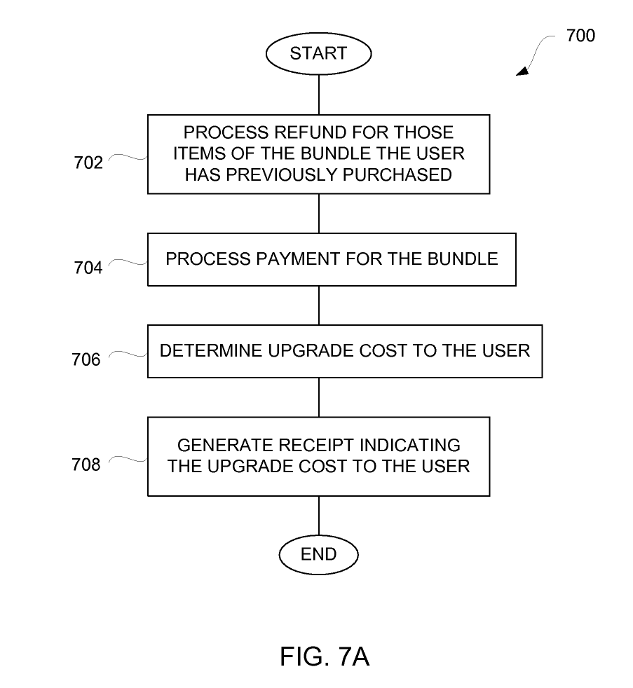

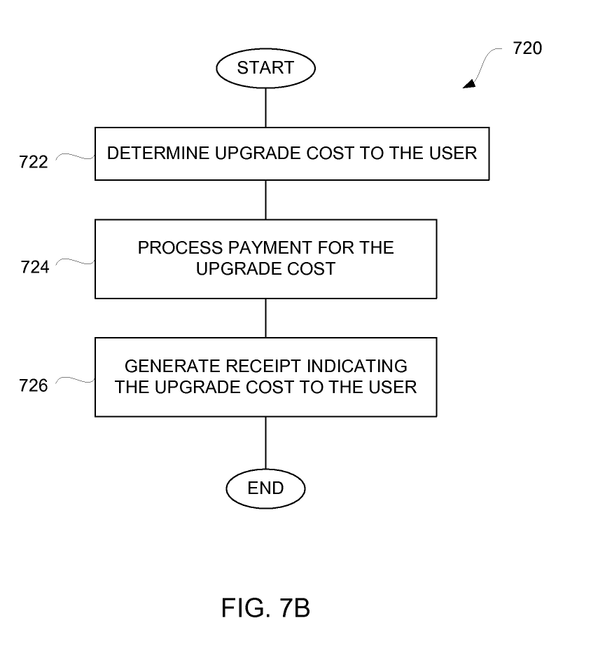

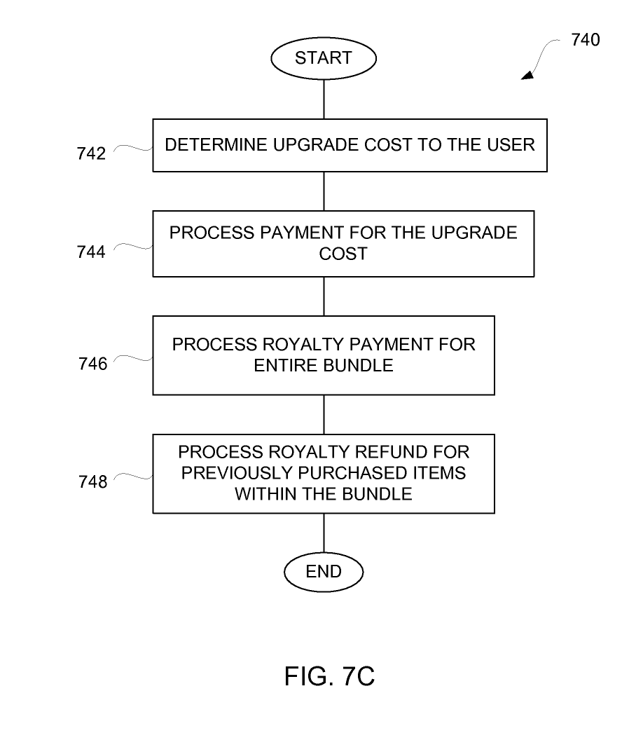

FIG. 7A is a flow diagram of a payment process 700 according to one embodiment of the invention. The payment process 700 can represent at least a portion of the processing associated with the block 510 illustrated in FIG. 5. The payment process 700 initially processes 702 a refund for those items of the bundle the user has previously purchased. For example, if the user previously purchased two items from the bundle at one (1) dollar each, the refund process would refund two (2) dollars to the user. Next, the payment for the bundle is processed 704. Here, in one embodiment, the bundle has a predetermined price which is the cost for purchase of the bundle. Hence, payment of the predetermined price for the bundle can be processed 704. For example, the bundle could be available at a cost of ten (10) dollars. Hence, payment for the bundle would be processing the ten (10) dollar payment. Next, an upgrade cost for the user can be determined 706. Here, the upgrade cost to the user is, according to one embodiment, the difference in the cost of the bundle less the cost of the items of the bundle previously purchased. In the example provided above, the cost of the bundle is ten (10) dollars and the cost of the previously purchased items is a total of two (2) dollars. Hence, the upgrade cost to the user for upgrading to the bundle would be ten (10) dollars minus two (2) dollars which equals eight (8) dollars. In addition, a receipt indicating the upgrade cost to the user can be generated 708. Here, in this embodiment, the user is provided a receipt indicating the particular upgrade cost that has been effectively charged to the user for the upgrade. However, the payment system, in this embodiment, processes the transaction as a refund of the prior purchase(s) together with a payment for the bundle, which is two transactions. The net result is that the user is charged the upgrade cost and thus such amount appears on the receipt.

FIG. 7B is a flow diagram of a payment process 720 according to another embodiment of the invention. The payment process 720 can represent at least a portion of the processing associated with the block 510 illustrated in FIG. 5. The payment process 720 determines 722 an upgrade cost for the user. Here, the upgrade cost to the user is, according to one embodiment, the difference in the cost of the bundle less the cost of the items of the bundle previously purchased. Next, the payment for the upgrade cost for the bundle can be processed 724. In addition, a receipt indicating the upgrade cost to the user can be generated 726.

FIG. 7C is a flow diagram of a payment process 740 according to another embodiment of the invention. The payment process 740 can represent at least a portion of the processing associated with the block 510 illustrated in FIG. 5. The payment process 740 determines 742 an upgrade cost for the user. Here, the upgrade cost to the user is, according to one embodiment, the difference in the cost of the bundle less the cost of the items of the bundle previously purchased. Next, the payment for the upgrade cost for the bundle can be processed 744.

Royalty payments are often required to be provided to media content owners/distributors. In the case of music, the owners/distributors are often referred to as labels. The payment process 740 can also provide for processing of royalty payments. In particular, the payment process 740 can process 746 royalty payment for the entire bundle (even though purchaser is only acquiring a portion of the bundle via upgrade). In addition, the payment process 740 can process 748 royalty refund for previously purchased items within the bundle. In this embodiment, the royalty payment is processed in two transactions. However, in an alternative embodiment, the royalty payment could be processed in a single transaction for a net royalty due for the upgrade. Further, in the embodiment of FIG. 7C, the payment for the upgrade to the bundle can be processed as a single transaction. Alternatively, the payment for the upgrade to the bundle can be processed as two transactions such as utilized in the embodiment of FIG. 7A.

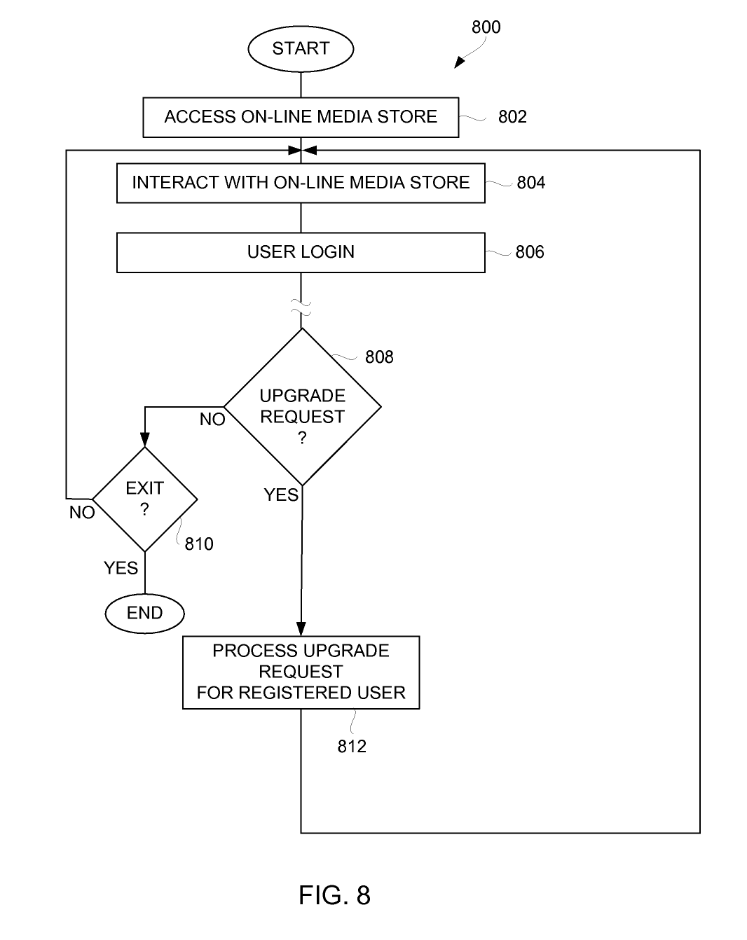

FIG. 8 is a flow diagram of an upgrade request process 800 according to one embodiment of the invention. The upgrade request process 800 is, for example, performed by a server, such as the media store server 102 or the digital media manager 114 illustrated in FIG. 1.

The upgrade request process 800 begins with access 802 to an on-line media store. Typically, a user will access 802 the on-line media store via a data network, such as the Internet. Once the user has accessed 802 the on-line media store, the user can interact 804 with the on-line media store. The interaction 804 with the on-line media store can, for example, involve searching, browsing, displaying, previewing, purchasing, and/or organizing digital media assets. Although the upgrade request process 800 is primarily provided by a server, such as the media store server 102 illustrated in FIG. 1, the access 802 and the interaction 804 can be facilitated by a computer program (e.g., media management application) operating on a client device, such as the client device 104 illustrated in FIG. 1. While interacting with the on-line media store, the user may login 806 with the on-line media store. Once logged in to the on-line media store, registration information (e.g., user purchase history, account information, etc.) associated with the user can be available to the server.

Next, a decision 808 determines whether an upgrade request has been received. In one embodiment, when media store content for a set (e.g., collection or bundle) of media items is displayed by the on-line media store, an “upgrade purchase” control (e.g., button) can be presented to the user. By selection of the “upgrade purchase” control, the user can initiate an upgrade request. When the decision 806 determines that an upgrade request has not been received, a decision 810 determines whether the upgrade request process 800 should be exited. When the decision 810 determines that the upgrade purchase request process 800 should not be exited, then the upgrade request process 800 returns to repeat the operation 804 and subsequent operations, though the login 806 can be bypassed when the user is already logged in. Alternatively, when the decision 810 determines that the upgrade request process 800 should exit, then the upgrade request process 800 ends.

On the other hand, when the decision 808 determines that an upgrade request has been received, then the upgrade request for a particular set of digital media assets is processed 812 for the user. For example, the upgrade request can purchase a set of media items such that it is associated with the user (e.g., associated with the user account for the user). Once purchased, the user acquires the various digital media assets within the particular set of media items that has been purchased. Following the operation 812, the upgrade request process 800 returns to repeat the operation 804 and subsequent operations so that additional interaction 804 with the on-line media store is permitted, including making additional upgrade requests if so desired.

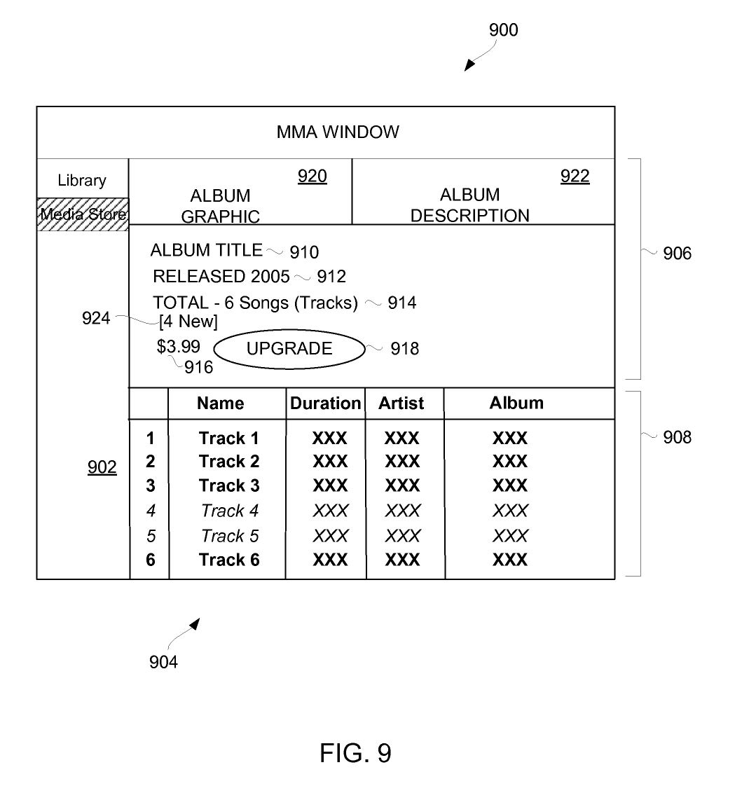

FIG. 9 is a diagram of a representative media upgrade window 900 according to one embodiment of the invention. The media upgrade window 900 is typically presented on a display device associated with a client device when the client device is interacting with the on-line media store via a computer program, such as a Media Management Application (MMA) or a network browser. The contents window 900 can be provided locally or remotely. When provided remotely, the content for the media upgrade window 900 can be provided by a web site. More particularly, when the user is interacting with the on-line media store to view information pertaining to a set of media items, namely, an album, that is available for purchase on the on-line media store, the on-line media store can also cause the media upgrade window 900 to be presented on the display device. The media upgrade window 900 includes a source portion 902 and a media descriptive portion 904. The source portion 902 indicates the source for the information being presented in the media descriptive portion 904. In this example, the source portion 902 indicates that a “Media Store” has been selected, such that the information being presented in the media descriptive portion 904 is information provided by an on-line media store. In this case, the information corresponds to one of a plurality of albums of music that are available for purchase from the on-line media store. The media descriptive portion 904 includes an album information portion 906 and a track listing area 908. The album information portion 906 includes information pertaining to the album. Hence, the album information portion 906 includes an album title 910, a release date 912, total number of tracks 914 for the album, a total cost 916 for the upgrade to the album, and an “UPGRADE” button 918. Upon selecting the “UPGRADE” button 918, the user requests to upgrade to the purchase of the particular album. The album information area 906 can also display an album graphic 920 and an album description 922 for the album. The album graphic 920, for example, can be a still graphic, animated graphics or video associated with the album. The album description 922 can provide additional detail on the album being purchased.

The track listing area 908 illustrates the tracks of the album. For each of the tracks listed in the track listing area, the name, duration, artist and album for such tracks can be displayed in the track listing area 908. In this example, it is assumed that the user already has tracks 4 and 5 of the album. As such, tracks 4 and 5 are visually distinguished (e.g., italicized, grayed-out, labeled, symbols, etc.) from the other tracks of the album. Some examples of labeling is to denote such tracks are “previously downloaded,” “previously acquired,” “already purchased”, etc. Hence, by upgrading to the album, the user acquires tracks 1-3 and 6. Optionally, the album information area 906 can also include an indication on what portion of the album the user will acquire on upgrade. For example, in the example illustrated in FIG. 9, a visual indication 924 is provided. The visual indication 924 is “4 new” indicating to the user that if they upgrade they will gain four additional tracks from the album that they do not presently have. The visual indication could take various other forms, such as a graphical representation or other numerical or symbol representation.

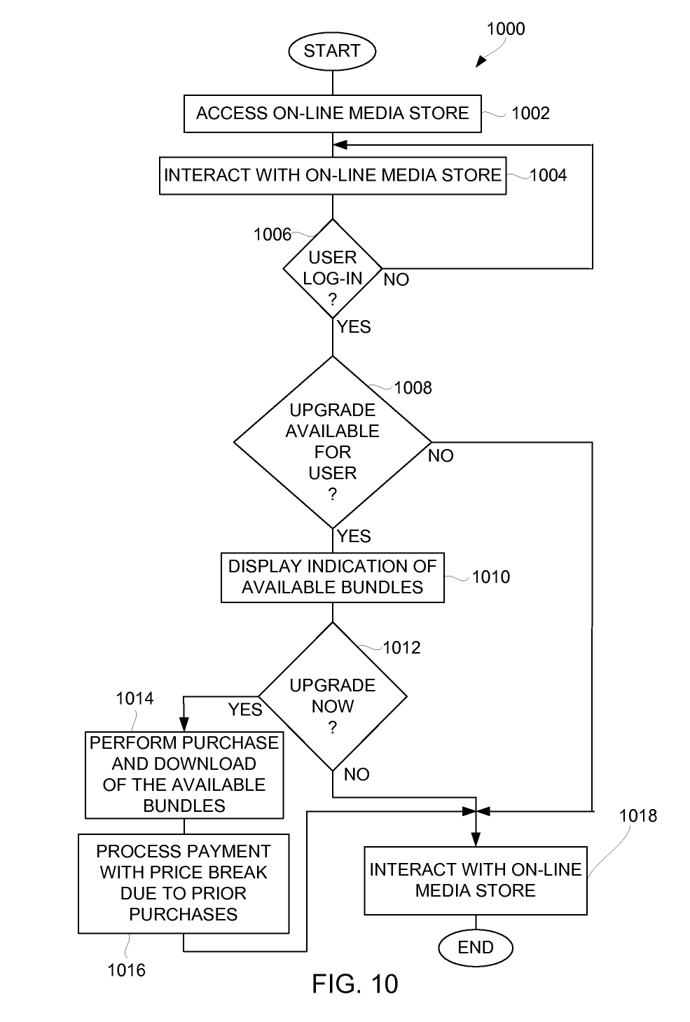

FIG. 10 is a flow diagram of a media bundle purchase process 1000 according to one embodiment of the invention. The media bundle purchase process 1000 concerns the purchase and delivery of bundles of media items to users that have requested to upgrade.

The media bundle purchase process 1000 initially involves access 1002 to an on-line media store. Typically, a user gains access 1002 to the on-line media store via a data network, such as the Internet. After the user has access 1002 to the on-line media store, the user can interact 1004 with the on-line store. Certain interactions with the on-line media store, such as purchasing and downloading, require that the user be a registered user. In this regard, the on-line media store requires that a user log in to authenticate that the user is indeed a registered user of the on-line media store. Hence, when the interaction 1004 requires such login, a decision 1006 determines whether the user has successfully logged in to the on-line media store. When the decision 1006 determines that the user has not yet logged in, then the media bundle purchase process 1000 returns to repeat the operation 1004 for other interaction with the on-line media store.

On the other hand, when the decision 1006 determines that the user has successfully logged-in, a decision 1008 determines whether any upgrades are available for the user. When the decision 1008 determines that there are one or more upgrades available for the user, an indication of the one or more available bundles is displayed 1010 for the user. For example, a dialog box can be presented on a display screen that the user is able to view. The dialog box can list the one or more available bundles and allow the user to choose the one or more available bundles. As another example, a web page, GUI window or a portion of a display screen can present to the user those bundles that are available for upgrade.

Thereafter, a decision 1012 determines whether the user desires to upgrade to the one or more available bundles at this time. When the decision 1012 determines that the user does desire to upgrade to the one or more available bundles, purchase and download of the one or more available bundles is performed 1014. Also, payment for the one or more available bundles can be processed 1016. The payment for each of the one or more available bundles can provide a price break (i.e., discount) in view of prior purchases of items within the bundle. Following the decision 1012 when upgrade to the one or more available bundles is not desired or following the payment operation 1016 when upgrade to the one or more available bundles is desirable, additional interaction 1018 with the on-line media store can be provided for the user. Additionally, following the decision 1008 when there are no available upgrades for the user, the media bundle purchase process 1000 bypasses the operations 1010-1016 and proceeds to permit the additional interaction 1018 with the on-line media store. Eventually, when no further interaction 1018 with the on-line media store is desired, the media bundle purchase process 1000 ends.

Upgrade opportunities for a user can be presented in a variety of ways. As another example, an on-line media store can maintain purchase history information for its users (e.g., account holders or registered users). When a user accesses their user purchase history information, an indication of available upgrade opportunities can be presented to the user. As still another example, when an invoice or account statement is presented to a user it can include an indication of one or more upgrade opportunities. The indication can, for example, pertain to a link (e.g., hyperlink) to a web page (or network address) where the corresponding bundle is described and where upgrade to the bundle can be initiated via user interaction with the web page.

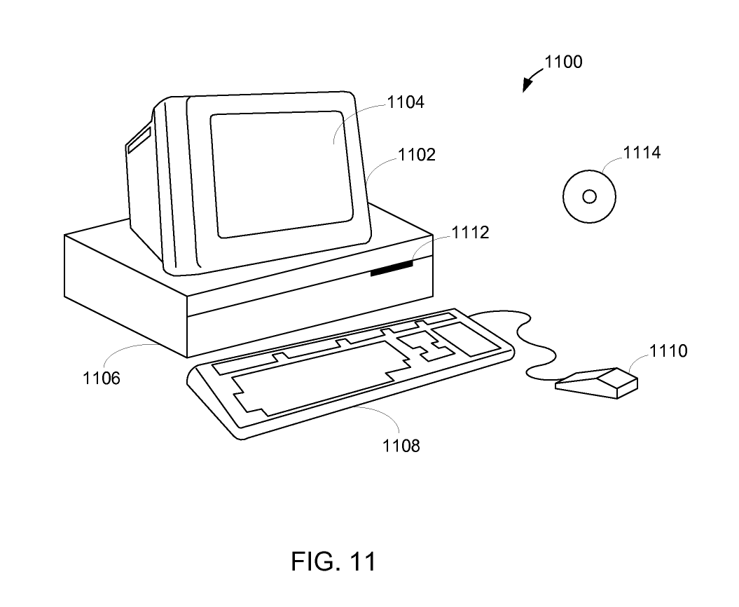

FIG. 11 shows an exemplary computer system 1100 suitable for use with the invention. Although the client device need not be a personal computer, the client device can be the exemplary computer system 1100 illustrated in FIG. 11. The computer system 1100 includes a display monitor 1102 having a single or multi-screen display 1104 (or multiple displays), a cabinet 1106, a keyboard 1108, and a mouse 1110. The cabinet 1106 houses a processing unit (or processor), system memory and a hard drive (not shown). The cabinet 1106 also houses a drive 1112, such as a CD-ROM or floppy drive. The drive 1112 can also be a removable hard drive, a Flash or EEPROM device, etc. Regardless, the drive 1112 may be utilized to store and retrieve software programs incorporating computer code that implements some or all aspects of the invention, data for use with the invention, and the like. Although CD-ROM 1114 is shown as an exemplary computer readable storage medium, other computer readable storage media including floppy disk, tape, Flash or EEPROM memory, memory card, system memory, and hard drive may be utilized. Additionally, a data signal embodied in a carrier wave (e.g., in a network) may be the computer readable storage medium. In one implementation, a software program for the computer system 1100 is provided in the system memory, the hard drive, the CD-ROM 1114 or other computer readable storage medium and serves to incorporate the computer code that implements some or all aspects of the invention.

The digital media assets (i.e., digital media items) can pertain to video items (e.g., video files or movies), audio items (e.g., audio files or audio tracks, such as for songs (music) or audiobooks), or image items (e.g., photos). The digital media assets can also include or be supplemented by text or multimedia files.

The various aspects, features, embodiments or implementations of the invention described above can be used alone or in various combinations.

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The advantages of the invention are numerous. Different aspects, embodiments or implementations may yield one or more of the following advantages. One advantage of the invention is that sets (e.g., groups or collections) of digital media assets can be supported by an on-line media store. Another advantage of the invention is that a set of digital media assets can be purchased in a cost effective manner even though the purchaser has previously purchased one of the digital media assets of the set. Still another advantage of the invention is that users can be notified in a computer automated manner of available upgrades that can be purchased. Yet still another advantage of the invention is that network and computing resources are able to be used more efficiently.

The following items are hereby incorporated herein by reference: (i) U.S. patent application Ser. No. 11/247,948, filed Oct. 10, 2005, and entitled “ON-LINE MEDIA STORE THAT SUPPORTS PRE-ORDERING OF DIGITAL MEDIA ASSETS;” (ii) U.S. patent application Ser. No. 11/212,314, filed Aug. 24, 2005, and entitled “ON-LINE MEDIA STORE THAT SUPPORTS PRE-ORDERING OF DIGITAL MEDIA ASSETS;” (iii) U.S. patent application Ser. No. 10/833,267, filed Apr. 26, 2004, and entitled “METHOD AND SYSTEM FOR NETWORK-BASED PURCHASE AND DISTRIBUTION OF MEDIA;” and (iv) U.S. patent application Ser. No. 10/687,534, filed Oct. 15, 2003, and entitled “METHOD AND SYSTEM FOR SUBMITTING MEDIA FOR NETWORK-BASED PURCHASE AND DISTRIBUTION.”

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method for upgrading a prior purchase of a user, said method comprising:
identifying the user as having previously made a prior purchase of an item from a particular online content provider;
determining whether the prior purchase is eligible for upgrade to a bundle of items, where the item is one of the items in the bundle of items;
notifying the user of their eligibility to upgrade to the bundle of items;
determining whether the user requests to upgrade to the bundle of items; and
transacting the upgrade from the particular online content provider when said determining determines that the user desires to upgrade to the bundle of items.

2. A computer-implemented method as recited in claim 1, wherein said identifying limits the prior purchase to one or more prior purchases that have been made within a predetermined duration of time.

3. A computer-implemented method as recited in claim 1, wherein said identifying is based on at least purchase history information associated with the user, the purchase history information being stored or accessible by the particular online content provider.

4. A computer-implemented method as recited in claim 1, wherein said determining whether the prior purchase is eligible for upgrade comprises:
evaluating at least one business rule to determine whether the prior purchase is eligible for upgrade.

5. A computer-implemented method as recited in claim 1, wherein said determining whether the prior purchase is eligible for upgrade comprises:
determining the bundle of items associated with the prior purchase; and
determining whether the bundle of items is permitted to be upgraded via the particular online content provider.

6. A computer-implemented method as recited in claim 1, wherein said notifying sends an email notification to the user.

7. A computer-implemented method as recited in claim 6, wherein the email notification includes a hyperlink to a web page where the bundle of items is described and where upgrade to the bundle of items can be initiated via user interaction with the web page.

8. A computer-implemented method as recited in claim 1, wherein said notifying comprises inviting the user to upgrade to the bundle of items.

9. A computer-implemented method as recited in claim 1, wherein said notifying comprises presenting a visual notification on a web page.

10. A computer-implemented method as recited in claim 9, wherein the web page is associated with the bundle of items.

11. A computer-implemented method as recited in claim 1, wherein said notifying comprises displaying an upgrade user interface control.

12. A computer-implemented method as recited in claim 11, wherein said determining of whether the user requests to upgrade to the bundle of items comprises:
receiving a user selection of the upgrade user interface control.

13. A computer-implemented method as recited in claim 1, wherein said notifying comprises:
displaying a list of one or more items that have been previously purchased,
wherein the list of the one or more items that have been previously purchased includes one or more upgrade controls displayed therein.

14. A computer-implemented method as recited in claim 1, wherein the user can request to upgrade from the one or more of the items that have been previously purchased to the bundle of items by selecting one of the one or more upgrade controls.

15. A computer-implemented method as recited in claim 1, wherein said transacting of the upgrade comprises:
determining an effective cost for the bundle of items; and
processing payment of the bundle of items in accordance with the effective cost.

16. A computer-implemented method as recited in claim 1, wherein said transacting of the upgrade comprises:
refunding prior payment for the item; and
processing payment of the bundle of items.

17. A computer-implemented method as recited in claim 16, wherein said notifying comprises:
presenting an effective cost for the bundle of items to the user.

18. A computer-implemented method as recited in claim 16, wherein the effective cost for the upgrading to the bundle of items is less than the cost of the bundle of items.

19. A computer-implemented method as recited in claim 16, wherein the effective cost for the upgrading to the bundle of items is less than the cost of the bundle of items and dependent on the number of prior purchases of items that are within the bundle of items.

20. A computer-implemented method as recited in claim 16, wherein said refunding and said processing are performed electronically.

21. A computer-implemented method as recited in claim 1, wherein said method further comprises:
sending, to the user, only those items of the bundle of items that the user does not already have from one or more prior purchases from the particular online content provider.

22. A computer-implemented method as recited in claim 1, wherein the bundle of items pertains to an album, and the items are audio tracks.

23. A computer-implemented method as recited in claim 1, wherein the bundle of items pertains to a video album, and the items are videos.

24. A computer-implemented method as recited in claim 1, wherein the bundle pertains to a television series, and the items are episodes of the television series.

25. A computer-implemented method as recited in claim 1, wherein the bundle of items pertains to a podcast, and the items are episodes of the podcast.

26. A computer readable medium including at least computer program code for offering an upgrade from a prior purchase of a media item to a set of media items that includes the media item, said computer readable medium comprising:
computer program code for identifying the user as having previously made a prior purchase of a media item from a particular online content provider;
computer program code for determining whether the prior purchase is eligible for upgrade to a set of media items, where the media item is one of the media items in the set of media items; and
computer program code for notifying the user of their eligibility to upgrade to the set of media items.

27. A computer readable medium as recited in claim 26, wherein said computer readable medium further comprises:
computer program code for determining whether the user requests to upgrade to the set of media items; and
computer program code for transacting the upgrade when it is determined that the user desires to upgrade to the set of media items.

28. A computer readable medium as recited in claim 27, wherein said computer program code for transacting operates to transact the upgrade with the particular online content provider.

29. A computer readable medium as recited in claim 1, wherein the set of items pertains to an album, a television series, or a podcast.

30. A computing device, comprising:
at least one data storage device, said data storage device storing digital media assets and digital media asset information that contains characteristics of the digital media assets, said data storage device further stores purchase history information, the digital media asset information including information on sets of the digital media assets that can be acquired; and
a data processing unit operatively connected to said at least one storage device, said data processing unit including at least:
an upgrade process to determine one or more available upgrade opportunities for one or more users based on the purchase history information, the upgrade opportunities pertaining to one or more of the sets of the digital media assets;
a notification process to notify one or more users of the one or more available upgrade opportunities; and
an acquisition process to enable the one or more users to upgrade to one or more of the sets of the digital media assets.

31. A computing device as recited in claim 30, wherein said data processing unit further includes:
an upgrade purchase process to enable a user to request purchase of one or more of the sets of the digital media assets; and
an acquisition process that facilitates acquisition of the one or more of the sets of the digital media assets.

32. A computing device as recited in claim 30, wherein said computing device is a media server.

33. A computing device as recited in claim 32, wherein the media server provides an online media store.

34. A computing device as recited in claim 30, wherein the set of items pertains to an album, a television series, or a podcast.

35. (canceled)

36. (canceled)

37. (canceled)

38. (canceled)

39. (canceled)

40. (canceled)
